(19) United States
(12) Patent Application Publication
(10) Pub. No.: US 2026/0156371 A1
(43) Pub. Date: Jun. 4, 2026

(54) COLOR CORRECTION METHOD FOR FILTER-LESS PIXELS

(71) Applicant: OMNIVISION TECHNOLOGIES, INC., Santa Clara, CA (US)

(72) Inventor: Alexander Kalnitsky, San Francisco, CA (US)

(21) Appl. No.: 18/968,153

(22) Filed: Dec. 4, 2024

(51) Int. Cl. H04N 23/85; H04N 9/67; H04N 25/78

(52) U.S. Cl. CPC H04N 23/85; H04N 9/67; H04N 25/78

(57) ABSTRACT

A color correction method for filter-less pixels is disclosed. In one embodiment, an image sensor, having a pixel array, includes a plurality of filter-less pixels. Each pixel of the plurality of filter-less pixels includes a blue light region, a green light region, and a red light region. Incoming light successively passes through the blue, green and red light regions, and a readout circuitry, configured to receive color signal outputs comprising blue region signals from the blue light region, green region signals from the green light region, .red region signals the red light region, and correct color signal outputs with a correction algorithm, including a blue light correction algorithm, a red light correction algorithm, and a green light correction algorithm, The method is configured to output corrected color signals provided by the correction algorithm.

### BACKGROUND INFORMATION

### Field of the Disclosure

This disclosure relates generally to the design of image sensors, and in particular, relates to methods of color correcting filter-less pixels of image sensors.

### Background

Image sensors have become ubiquitous. They are widely used in digital still cameras, cellular phones, security cameras, as well as medical, automotive, and other applications. The technology for manufacturing image sensors continues to advance at a great pace. For example, the demands for higher image sensor resolution and lower power consumption motivate further miniaturization and integration of image sensors into digital devices.

Image sensors operate in response to image light coming from an external scene and being incident upon the image sensor. An image sensor includes an array of pixels having photosensitive elements (e.g., photodiodes) that absorb a portion of the incident image light and in response generate corresponding electrical charge. The electrical charge of individual pixels may be measured as an output voltage of each photosensitive element. In general, the output voltage varies as a function of the intensity and duration of the incident light. The output voltage of individual photosensitive elements is used to produce a digital image (i.e., image data) representing an external scene.

In some applications, image sensors include filter-less pixels having regions for absorbing different wavelengths of light, such as blue, green, and red light. Some claim that light color detection occurs at the depth where the light absorption is at its maximum, and light detection schemes for filter-less pixels imply full absorption of blue light in a blue light region, green light in a green light region, and red light in a red light region. In reality, there is some absorption of both green and red light in the blue light region as well as blue and red light absorption in the green light region and green light absorption in the red light region of the vertical diode stack. Accordingly, light correction schemes to compensate for the color contaminating absorption for all three wavelengths of interest are still needed.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is an example image sensor, in accordance with the present technology.

FIG. 2A is an example cross section of a pixel of the pixel array, in accordance with the present technology.

FIG. 2B is an example closeup of pixel circuitry of FIG. 2A, in accordance with the present technology.

FIG. 3 is an example representation of a pixel circuit, in accordance with the present technology.

FIG. 4 is a method of color-correcting filter-less pixels of an image sensor, in accordance with the present technology.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Image sensors, and particularly color correcting methods for filter-less pixels in image sensors are disclosed. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one example” or “one embodiment” means that a particular feature, structure, or characteristic described in connection with the example is included in at least one example of the present invention. Thus, the appearances of the phrases “in one example” or “in one embodiment” in various places throughout this specification are not necessarily all referring to the same example. Furthermore, the particular features, structures, or characteristics may be combined in any suitable manner in one or more examples.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Where methods are described, the methods may include more, fewer, or other steps. Additionally, steps may be performed in any suitable order. Accordingly, the disclosure can encompass other embodiments not expressly shown or described herein. In the context of this disclosure, the terms “about,” “approximately,” etc., mean+/−5% of the stated value.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

Briefly, the embodiments of the present technology are directed to image sensors and methods of color-correcting filter-less pixels in image sensors. In some embodiments, each pixel of a plurality of pixels in an image sensor includes a region for absorbing blue light, a region for absorbing green light, and a region for absorbing red light. Incoming light may successively pass through each of these regions to generate blue light signals, green light signals, and red light signals, respectively. In some embodiments, readout circuitry is configured to receive these light signals and correct them with a correction algorithm. The correction algorithm may include a blue light correction algorithm configured to correct the blue region signals by a first amount of green light and a second amount of red light absorbed within the blue light region, a red light correction algorithm configured to correct the red region signals by a third amount of blue light and a fourth amount of red light absorbed within the red light region, and a green light correction algorithm configured to correct the green region signals by a fifth amount of blue light and a sixth amount of red light absorbed within the green light region.

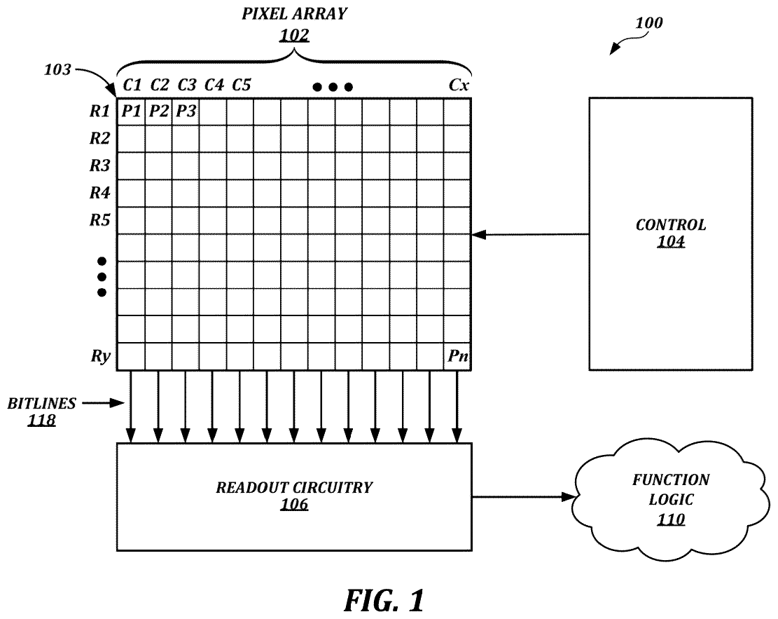

FIG. 1 is an example image sensor 100, in accordance with the present technology. FIG. 1 illustrates an example imaging system 100 in accordance with an embodiment of the present disclosure. The imaging system 100 includes a pixel array 102, a control circuitry 104, a readout circuitry 106 (also referred to as a pixel circuitry) and a function logic 110. In one example, the pixel array 102 is a two-dimensional (2D) array of photodiodes or image sensor pixels 112 (e.g., pixels P1, P2 . . . , Pn). As illustrated, the photodiodes are arranged into rows (e.g., rows R1 to Ry) and columns (e.g., column C1 to Cx). In operation, the photodiodes acquire image data of an outside scene, which can then be used to render a 2D image of the person, place, object, etc. However, in other embodiments the photodiodes may be arranged into configurations other than rows and columns.

In an embodiment, after each pixel 112 in the pixel array 102 acquires its image charge, the image data is read out by the readout circuitry 106 via bitlines 118, and then transferred to a function logic 110. In various embodiments, the readout circuitry 106 may include signal amplifiers, analog-to-digital (ADC) conversion circuitry and data transmission circuitry. The function logic 110 may store the image data or even manipulate the image data by applying post image effects (e.g., crop, rotate, remove red eye, adjust brightness, adjust contrast, or otherwise). In some embodiments, the control circuitry 104 and function logic 110 may be combined into a single functional block to control the capture of images by the pixels 112 and the readout of image data from the readout circuitry 106. The function logic 110 may be a digital processor, for example. In one embodiment, the readout circuitry 106 may read one row of image data at a time along readout column lines (bitlines 118) or may read the image data using a variety of other techniques, such as a serial readout or a full parallel readout of all pixels simultaneously (not illustrated).

In one embodiment, the control circuitry 104 is coupled to the pixel array 102 to control operation of the plurality of photodiodes in the pixel array 102. For example, the control circuitry 104 may generate a shutter signal for controlling image acquisition. In one embodiment, the shutter signal is a global shutter signal for simultaneously enabling all pixels within the pixel array 102 to simultaneously capture their respective image data during a single data acquisition window. In another embodiment, the shutter signal is a rolling shutter signal such that each row, column, or group of pixels is sequentially enabled during consecutive acquisition windows. In another embodiment, image acquisition is synchronized with lighting effects such as a flash.

In one embodiment, readout circuitry 106 includes analog-to-digital converters (ADCs), which convert analog image data received from the pixel array 102 into a digital representation. The digital representation of the image data may be provided to the function logic 110. In some embodiments, the data transmission circuitry 108 may receive the digital representations of the image data from the ADCs in parallel and may provide the image data to the function logic 110 in series.

In different embodiments, imaging system 100 may be included into a digital camera, cell phone, laptop computer, or the like. Additionally, imaging system 100 may be coupled to other pieces of hardware such as a processor (general purpose or otherwise), memory elements, output (USB port, wireless transmitter, HDMI port, etc.), lighting/flash, electrical input (keyboard, touch display, track pad, mouse, microphone, etc.), and/or display. Other pieces of hardware may deliver instructions to imaging system 100, extract image data from imaging system 100, or manipulate image data supplied by imaging system 100.

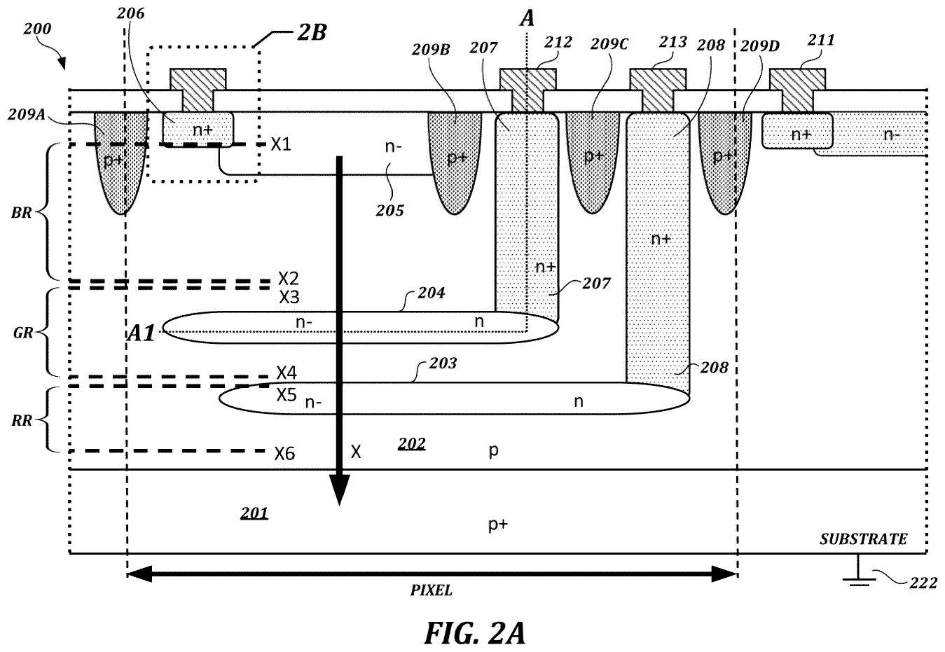

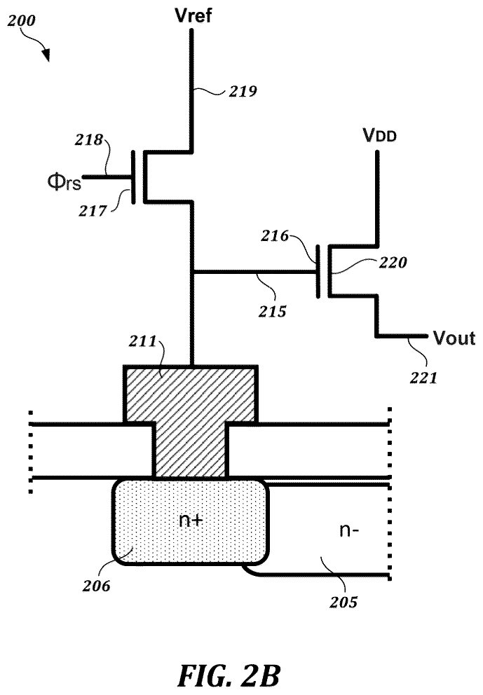

FIG. 2A is an example cross section of a pixel of a pixel array 200, in accordance with the present technology. In some embodiments, the pixel is a pixel of a complementary metal-oxide semiconductor (CMOS).

Pixel array 200 has a p+ type substrate 201. In some embodiments, a P type doped region 202 may be epitaxially deposited on substrate 201. In some embodiments, the P type doped region 202 may extend all the way to a surface of the pixel array. Region 202 may include vertically stacked n type doped regions 203, 204 and 205. In some embodiments, the vertically stacked n type doped regions 203, 204 and 205 may be formed by ion implantation between consecutive epitaxial growth steps. In some embodiments, vertically stacked n type doped regions 203, 204 and 205 may be formed by other means. Various techniques are well known to those skilled in the art of modern silicon device fabrication processing technology and the descriptions herein are not meant to be limiting. In some embodiments, the n type doped regions 203, 204, and 205 are only lightly doped such that they are depleted during normal operation of the pixel.

Similarly, n+ type doped vertical extensions (also referred to herein as “plugs”) 206, 207, and 208 may be formed by ion implantation between epitaxial growth steps and serve as conductive connections that enable biasing and collection of photo-generated electrons in doped layers 203, 204 and 205 from the surface of the silicon substrate 201.

In some embodiments, plugs 206, 207, and 208 are contacted by metal regions 211, 212, and 213. In some embodiments, the metal regions 211, 212, and 213 may be formed through holes in a silicon-dioxide dielectric layer 210, or as multilevel interconnects over many types of dielectric layers. Various techniques are well known to those skilled in the art of modern silicon device fabrication processing technology and the descriptions herein are not meant to be limiting. Metal regions 211, 212, and 213 may be formed by a single metal, such as aluminum, or composed of complex metallization systems formed by various layers of titanium-nitride, titanium, tungsten, aluminum, cooper, and so on. Metal regions 211, 212, and 213 are then interconnected with various circuit components by metal wiring.

To prevent parasitic surface channel conduction and shorting together of plugs 206, 207 and 208, p+ type doped isolation regions (also referred to herein as “channel stops”) 209A, 209B, 209C, 209D are inserted between each of plugs 206, 207 and 208. In some embodiments, the channel stops 209A, 209B, 209C, 209D completely surround each of corresponding plugs 206, 207 and 208 in the direction that is perpendicular to the plane of drawing (not pictured in FIG. 2A.)

When driven to a sufficiently high voltage, the n type doped regions 203, 204, and 205 may not form conductive electrodes of a detection node capacitor, rather, the n type doped regions 203, 204, and 205 form depleted potential wells. When charge is generated in region 202 at various depths it diffuses first vertically to one region of the n type doped regions 203, 204, and 205 203, 204, and 205, and then laterally within the n type doped regions 203, 204, and 205 to corresponding plugs 208, 207, and 206.

In some embodiments, the filter-less pixel includes a blue light region BR, which spans from a vertical depth X1 to X2, a green light region GR, which spans from X3 to X4, and a red light region RR, which spans from X5 to X6. The conventional light detection scheme implies full absorption of blue light in the region labelled X1 to X2 (i.e., the boundaries of the region extending from X1 to X2), green light in the region labelled X3 to X4 and red light in the region labelled X5 to X6. Some claim that light color detection occurs at the depth where the light absorption is at its maximum, and light detection schemes for filter-less pixels imply full absorption of blue light in the region labelled X1 to X2, green light in the region labelled X3 to X4 and red light in the region labelled X5 to X6. In reality, there is some absorption of both green and red light in the blue light region BR as well as blue and red light absorption in the green light region GR and green light absorption in the red light region RR of the vertical diode stack.

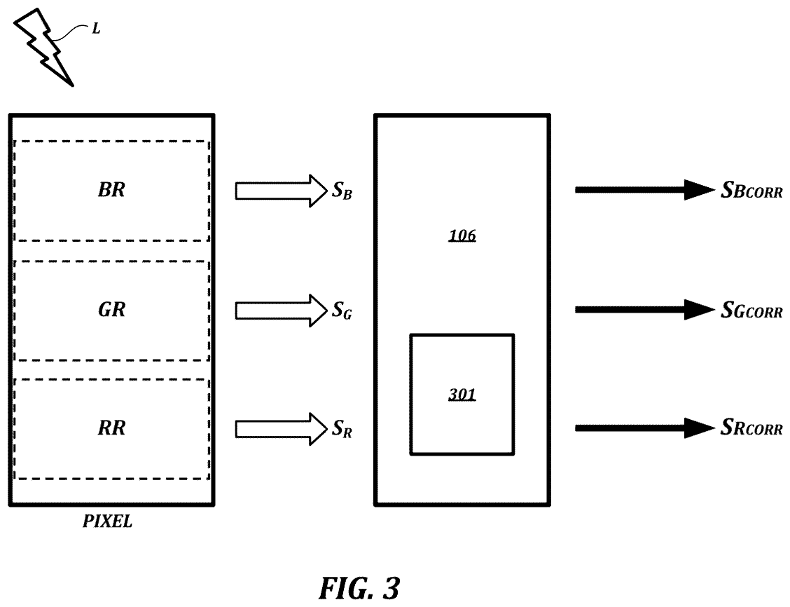

Accordingly, the present technology further includes output circuitry, as shown and described in FIG. 3, to correct and compensate for the color contaminating absorption for all three wavelengths (blue light, green light, and red light) of interest.

In some embodiments, the image sensor disclosed herein includes pixels where colors (such as red, blue, and green) of light are separated by the depth of penetration in Si. That is, the red region, the blue region, and the green region, which respectively absorb red, blue, and green light are separated by the depth of penetration in the Si. In some embodiments, the pixels of the image circuit are FOVEON™ pixels.

A closeup of section 2B of FIG. 2A, showing example pixel circuitry, is shown and described in FIG. 2B.

FIG. 2B is an example closeup of pixel circuitry of FIG. 2A, in accordance with the present technology. The circuit may include a reset transistor 217 that connects charge detection node 215 to reference voltage terminal 219 when a suitable reset level is applied to gate 218. In some embodiments, photo-generated charge accumulating on node 215 causes a voltage charge that is buffered by transistor 216 with its drain connected to Vad bias terminal 220. The output signal then appears on node 221 and can be further processed either as a voltage or as a current when supplied to the rest of the sensor circuitry. Circuit ground 222 (as shown in FIG. 2B) may be identical to p+ type doped substrate 201 (as shown in FIG. 2B.) For a single pixel that senses three colors, each color has a circuit including reset transistor 217 and amplifier transistor 216. One skilled in the art would recognize that more complex circuits may be connected to pixel 200.

When a reset voltage is applied to node 215 and the corresponding two remaining nodes (circuits connected to plugs 206 and 207), the potential of these nodes is raised to the reference bias level V_{rf}. When the doping level of layer 203 (as well as layers 204 and 205) is sufficiently high, the potential at node 215, the potential of plug 208 (as well as plugs 207 and 206), and the potential of layer 203 (as well as layers 204 and 205) are approximately the same. Layer 203 and plug 208, which are buried reverse biased diodes, act as a single electrode of a junction capacitor. The capacitance of such a structure is higher relative to the desired capacitance of pixel 200, since the junction area surrounding layer 203 on all sides is large.

When node 215 is reset to a sufficiently high voltage, only the potential of node 215 and corresponding plug 208 changes. The potential of region 203 remains relatively constant and does not change significantly during reset of the pixel. Capacitance of node 215, therefore, consists of the capacitance of plug 208 and the input capacitance of the circuit at node 215. The capacitance can be minimized by appropriately sizing transistors and structures and in addition do not depend on the size of the regions 203, 204, and 205, and thus do not depend on the size of the pixel. Reduced capacitance contributes to higher pixel sensitivity and lower noise.

FIG. 3 is an example representation of a pixel circuit, in accordance with the present technology. In order to color-correct a filter-less pixel (such as the pixel shown in FIGS. 2A-2B), in some embodiments, the pixel array 300 includes readout circuitry 106 configured to express correction factors in terms of each color output signal and pixel parameters. In some embodiments, these pixel parameters may be obtained by Technology Computer Aided Drafting (TCAD) and/or measurements. In some embodiments, the correction factors are then subtracted from color outputs outside of the pixel, in the circuit.

In some embodiments, disclosed herein is an image sensor, including a pixel array. The pixel array may include a plurality of filter-less pixels. For simplicity, single pixel is illustrated in FIG. 3. In some embodiments, each pixel of the plurality of filter-less pixels includes a blue light region BR, a green light region GR, and a red light region RR. In operation, incoming light L successively passes through the blue BR, green GR and red light RR regions. In some embodiments, the image sensor further includes a readout circuitry 106, configured to receive color signal outputs comprising blue region signals S_{B} from the blue light region BR, receive green region signals S_{G} from the green light region GR, and receive red region signals S_{R} from the red light region RR.

In some embodiments, the readout circuitry may also correct color signal outputs with a correction algorithm. The correction algorithm may include a blue light correction algorithm configured to correct the blue region signals S_{B} by a first amount of green light and a second amount of red light absorbed within the blue light region BR, a red light correction algorithm configured to correct the red region signals S_{R} by a third amount of blue light and a fourth amount of red light absorbed within the red light region RR, and a green light correction algorithm configured to correct the green region signals S_{G} by a fifth amount of blue light and a sixth amount of red light absorbed within the green light region GR.

The readout circuitry may be further configured to output corrected color signals (S_{BCORR}, S_{GCORR}, and S_{RCORR}, respectively) provided by the correction algorithm. In some embodiments, the readout circuitry includes specific analog circuitry 301 configured to execute the correction algorithm.

Light penetration I vs. silicon (Si) depth is given by Equation 1.

$$I = {I}_{0} {e}^{- α X} \qquad Eq . 1$$

Here, I₀ is the intensity of impinging light, α is the absorption coefficient and X is the depth in Si, in the case of this pixel construction, this is the depth from the front of the Si surface.

Absorbed light between any two points X₁ and X₂ (such as X1, X2, X3, X4, and X5 shown in FIG. 2A) is calculated as shown in Equation 2.

$${I}_{Absorbed} = {I}_{0} {e}^{- α X 1} - {I}_{0} {e}^{- α X 2} = {I}_{0} {e}^{- α X 2} ( {e}^{α X 2 - α X 1} - 1 ) \qquad Eq . 2$$

In some embodiments, color signal outputs from the blue light region BR, green light region GR and red light region RR are shown in Equations 3, 4, and 5, respectively.

$${S}_{B} = {σ}_{B} {I}_{0 B} {e}^{- α bX 2} ( {e}^{α bX 2 - α bX 1} - 1 ) + {δ}_{GR} \qquad Eq . 3$$

$${S}_{G} = {σ}_{G} {I}_{0 G} {e}^{- α gX 4} ( {e}^{α gX 4 - α gX 3} - 1 ) + {δ}_{RB} \qquad Eq . 4$$

$${S}_{R} = {σ}_{R} {I}_{0 R} {e}^{- α rX 6} ( {e}^{α rX 6 - α rX 5} - 1 ) + {δ}_{BG} \qquad Eq . 5$$

Where σₙ (n=b, g, or r) is the absorbed light to signal conversion parameter at a given wavelength. Furthermore, αb, αg, and αr are wavelength-specific absorption coefficients for b, g, and r, I₀ₙ (n=b, g, r) is light intensity of the selected wavelength. On combines quantum efficiency and charge to voltage conversion efficiency. S_{B}, S_{G}, and S_{R} are raw outputs from blue region BR, green region GR, and red region RR, respectively. δ_{GR}, δ_{RB}, and δ_{BG} are additions to the output induced by the cross talk due to green-red, red-blue, and blue-green light absorption outside of their respective main absorption region.

In some embodiments, the δ factor is negligible and can be ignored. In such embodiments, the correction algorithm is configured to ignore δ_{BG}, δ_{RB}, δ_{GR}, or a combination thereof when δ_{BG}, δ_{RB}, and δ_{GR}, or a combination thereof are considered less than a predetermined threshold. Further, in such cases, the color signals outputs (S_{B}, S_{G}, S_{R}) are defined as shown in Equations 6, 7, and 8, respectively.

$${S}_{B} = {σ}_{B} {I}_{0 B} {e}^{- α bX 2} ( {e}^{α bX 2 - α bX 1} - 1 ) \to {σ}_{B} {I}_{0 B} = {S}_{B} {e}^{α bX 2} / ( {e}^{α bX 2 - α bX 1} - 1 ) \qquad Eq . 6$$

$${S}_{G} = {σ}_{G} {I}_{0 G} {e}^{- α gX 4} ( {e}^{α gX 4 - α gX 3} - 1 ) \to {σ}_{G} {I}_{0 G} = {S}_{G} {e}^{α gX 4} / ( {e}^{α gX 4 - α gX 3} - 1 ) \qquad Eq . 7$$

$${S}_{R} = {σ}_{R} {I}_{0 R} {e}^{- α rX 6} ( {e}^{α rX 6 - α rX 5} - 1 ) \to {σ}_{R} {I}_{0 R} = {S}_{R} {e}^{α rX 6} / ( {e}^{α rX 6 - α rX 5} - 1 ) \qquad Eq . 8$$

Accordingly, in some embodiments, the corrected light detection in blue region (i.e., the blue light correction algorithm) is defined by Equations 9a-9c:

$${S}_{{B}_{CORR}} = Raw Output of Blue Region - {δ}_{GR} \qquad Eq . 9 a$$

$$= {S}_{B} - [ {σ}_{G} {I}_{0 G} {e}^{- α gX 2} ( {e}^{α gX 2 - α gX 1} - 1 ) + {σ}_{R} {I}_{0 R} {e}^{- α rX 2} ( {e}^{α rX 2 - α rX1} - 1 ) \qquad Eq . 9 b$$

$${S}_{{B}_{CORR}} = {S}_{B} - [ {S}_{G} {e}^{α gX 4 e - α gX 2} ( {e}^{α gX 2 - α gX 1} - 1 ) / ( {e}^{α gX 4 - α gX 3} - 1 ) + {S}_{R} {e}^{α rX 6} {e}^{- α rX 2} ( {e}^{α rX 2 - α rX 1} - 1 ) / ( {e}^{α rX 6 - α rX 5} - 1 ) ] \qquad Eq . 9 c$$

Here, S_{B} is raw output of the blue light region, S_{G} is raw output of green light region, and S_{R} is raw output of red light region.

Similarly, in some embodiments, the corrected light detection in green region (i.e., the green light correction algorithm) is defined by Equations 10a-10b.

$${S}_{{G}_{CORR}} = Raw Output of Green Region - {δ}_{RB} \qquad Eq . 10 a$$

$${S}_{{G}_{CORR}} = {S}_{G} - [ {S}_{B} {e}^{α bX 2 e - α bX 4} ( {e}^{α bX 4 - α bX 3} - 1 ) / ( {e}^{α bX 2 - α bX 1} - 1 ) + {S}_{R} {e}^{α rX 6} {e}^{- α rX 4} ( {e}^{α rX 4 - α rX 3} - 1 ) / ( {e}^{α rX 6 - α rX 5} - 1 ) ] \qquad Eq . 10 b$$

In the above equations, S_{B} is raw output of the blue light region, S_{G} is raw output of green light region, and S_{R} is raw output of red light region.

Similarly, in some embodiments, the corrected light detection in red region (i.e., the red light correction algorithm) is defined by Equations 11a-11b.

$${S}_{{R}_{CORR}} = Raw Output of Red Region - {δ}_{RB} \qquad Eq . 11 a$$

$${S}_{{R}_{CORR}} = {S}_{R} - [ {S}_{B} {e}^{α bX 2 e - α bX 6} ( {e}^{α bX 6 - α bX 5} - 1 ) / ( {e}^{α bX 2 - α bX 1} - 1 ) + {S}_{G} {e}^{α gX 4} {e}^{- α gX 6} ( {e}^{α gX 6 - α gX 5} - 1 ) / ( {e}^{α gX 4 - α rX 3} - 1 ) ]$$

In the above equations, S_{B} is raw output of the blue light region, S_{G} is raw output of green light region, and S_{R} is raw output of red light region.

In some embodiments, the correction algorithm is executed in a matrix, as shown in Equation 12. In some embodiments, the correction algorithm includes digital processing.

$$\{ \begin{matrix}{S}_{{B}_{CORR}} \\ {S}_{{G}_{CORR}} \\ {S}_{{R}_{CORR}}\end{matrix} \} = \{ \begin{matrix}1 & - \frac{{e}^{ag X 4} {e}^{- ag X 2} ( {e}^{ag X 2 - ag X 1} - 1 )}{{e}^{ag X 4 - agX 3} - 1} & - {e}^{arX 6} {e}^{- arX 2} ( {e}^{arX 6 - ar X 5} - 1 ) ( {e}^{ar X 6 - ar X 5} - 1 ) \\ - \frac{{e}^{ab X 2} {e}^{- ab X 4} ( {e}^{abx 4 - ab X 3} - 1 )}{{e}^{ab X 2 - abX 1} - 1} & 1 & - {e}^{ar X 6} {e}^{- ar X 4} ( {e}^{ar X 4 - ar X 3} - 1 ) ( {e}^{ar X 6 - ar X 5} - 1 ) \\ - \frac{{e}^{ab X 2} {e}^{- ab X 4} ( {e}^{abx 4 - ab X 3} - 1 )}{{e}^{ab X 2 - abX 1} - 1} & - \frac{{e}^{ag X 4} {E}^{- ag X 6} ( {e}^{ag X 6 - ag X 5} - 1 )}{{e}^{ag X 4 - arX 3} - 1} & 1\end{matrix} \} \{ \begin{matrix}{S}_{B} \\ {S}_{G} \\ {S}_{R}\end{matrix} \} \qquad Eq . 12$$

In some embodiments, Equations 1-12 may be further defined by introducing an area factor based σₙ the pixel layout.

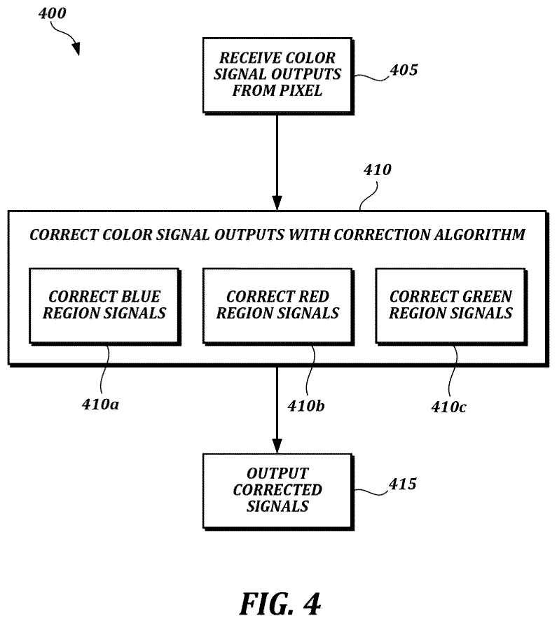

FIG. 4 is a method 400 of color-correcting filter-less pixels of an image sensor, in accordance with the present technology. The method 400 may be carried out by any of the image sensors disclosed herein, including image sensor 100, image sensor 200, and image sensor 300. In some embodiments, the image sensor includes a pixel array (such as pixel array 102) made up of a plurality of pixels (such as pixels 103). In some embodiments, each pixel of the plurality of pixels includes a red light region (such as red light region RR), a blue light region (such as blue light region BR), and a green light region (such as green light region GR). In some embodiments, incoming light (such as incoming light L) successively passes through the blue, green and red light regions.

In some embodiments, the image sensor further includes readout circuitry configured to execute a correction algorithm. The correction algorithm may include a red light correction algorithm, a blue light correction algorithm, and a green light correction algorithm.

In some embodiments, the image sensor further includes control circuitry (such a control circuitry 104) and/or function logic (such as function logic 110).

In block 405, color signal outputs are received from a pixel of the pixel array. As used herein, “color signal outputs” include red region signals (such as red region signals S_{R}), blue region signals (such as blue region signals S_{B}) and green region signals (such as green region signals S_{G}). In some embodiments, the pixel is a filter-less pixel. In some embodiments, the color signal outputs are generated based σₙ incoming light impinging σₙ the pixel and successively passes through the blue, green and red light regions.

In some embodiments, the blue region signals are defined as S_{B}=σ_{B}I_{0B}e^{-αbX2}(e^{αbX2-αbX1}−1)+δ_{GR}, wherein the green region signals are defined as S_{G}=σ_{G}I_{0G}e^{-αgX4}(e^{αgX4-αgX3}−1)+δ_{RB}, and wherein the red region signals are defined as S_{R}=σ_{R}I_{0R}e^{-αrX6}(e^{αrX6-αrX5}−1)+δ_{BG}, where S_{B}, S_{G}, and S_{R} are raw outputs from the blue region, the green region, and the red region, respectively, X1 to X2 define the blue region, X3 to X4 define the green region, X5 to X6 define the red region, δ_{GR}, δ_{RB}, and δ_{BG} are additions to the raw outputs induced by cross talk due to green-red, red-blue, and blue-green light, respectively, I₀ₙ (n=b, g, r) is light intensity of a selected wavelength, σₙ (n=b, g, r) is an absorbed light to signal conversion parameter at a given wavelength, and αb, αg, and αr are wavelength-specific absorption coefficients for b, g, and r, respectively.

In some embodiments, σ_{B}I_{0B}=S_{B}e^{αbX2}/(e^{αbX2-αbX1}−1). In some embodiments, σ_{G}I_{0G}=S_{G}e^{αgX4}/(e^{αgX4-αgX3}−1). In some embodiments, σ_{R}I_{0R}=S_{G}e^{αrX6}/(e^{αrX6-αrX5}−1).

In some embodiments, the correction algorithm is configured to ignore δ_{BG}, δ_{RB}, δ_{GR}, or a combination thereof when δ_{BG}, δ_{RB}, and δ_{GR}, or a combination thereof are considered less than a predetermined threshold.

In block 410, the color signal outputs are corrected with a correction algorithm, as described herein. In some embodiments, the correction algorithm includes a red light correction algorithm, a blue light correction algorithm, and a green light correction algorithm.

In block 410a, the blue region signals are corrected with the blue light correction algorithm. In some embodiments, the blue light correction algorithm configured to correct the blue region signals by a first amount of green light and a second amount of red light absorbed within the blue light region. In some embodiments, the blue light correction algorithm is defined as S_{B}−[σ_{G}I_{0G}e^{-αgX2}(e^{αgX2-αgX1}−1)+σ_{R}I_{0R}e^{αrX2}(e^{αrX2-αrX1}−1)].

In block 410b, the red region signals are corrected with the red light correction algorithm. In some embodiments, the red light correction algorithm is configured to correct the red region signals by a third amount of blue light and a fourth amount of red light absorbed within the red light region. In some embodiments, the red light correction algorithm is defined as S_{R}−[S_{B}e^{αbX2}e^{-αbX6}(e^{αbX6-αbX5}−1)/(e^{αbX2-αbX1}−1)+S_{G}e^{αgX4}e^{-αgX6}(e^{αgX6-αgX5}−1)/(e^{αgX4-αrX3}−1)].

In block 410c, the green region signals are corrected with the green light correction algorithm. In some embodiments, the green light correction algorithm is configured to correct the green region signals by a fifth amount of blue light and a sixth amount of red light absorbed within the green light region. In some embodiments, the green light correction algorithm is defined as S_{G}−[S_{B}e^{αbX2}e^{-αbX4}(e^{αbX4-αbX3}−1)/(e^{αbX2-αbX1}−1)+S_{G}e^{αrX6}e^{-αrX4}(e^{αrX4-αrX3}−1)/(e^{αrX6-αrX5}−1)].

In some embodiments, blocks 410a, 410b, and 410c (collectively, block 410) are executed as a matrix. In such embodiments, the correction algorithm is defined as:

$$\{ \begin{matrix}{S}_{{B}_{CORR}} \\ {S}_{{G}_{CORR}} \\ {S}_{{R}_{CORR}}\end{matrix} \} = \{ \begin{matrix}1 & - \frac{{e}^{ag X 4} {e}^{- ag X 2} ( {e}^{ag X 2 - ag X 1} - 1 )}{{e}^{ag X 4 - agX 3} - 1} & - {e}^{arX 6} {e}^{- arX 2} ( {e}^{arX 6 - ar X 5} - 1 ) ( {e}^{ar X 6 - ar X 5} - 1 ) \\ - \frac{{e}^{ab X 2} {e}^{- ab X 4} ( {e}^{abx 4 - ab X 3} - 1 )}{{e}^{ab X 2 - abX 1} - 1} & 1 & - {e}^{ar X 6} {e}^{- ar X 4} ( {e}^{ar X 4 - ar X 3} - 1 ) ( {e}^{ar X 6 - ar X 5} - 1 ) \\ - \frac{{e}^{ab X 2} {e}^{- ab X 4} ( {e}^{abx 4 - ab X 3} - 1 )}{{e}^{ab X 2 - abX 1} - 1} & - \frac{{e}^{ag X 4} {E}^{- ag X 6} ( {e}^{ag X 6 - ag X 5} - 1 )}{{e}^{ag X 4 - arX 3} - 1} & 1\end{matrix} \} \{ \begin{matrix}{S}_{B} \\ {S}_{G} \\ {S}_{R}\end{matrix} \}$$

In block 415, the corrected color signals are output based σₙ the correction algorithm. In some embodiments, the term “corrected color signals” includes a corrected red signal (such as corrected red signal S_{RCORR}), a corrected blue signal (such as corrected blue signal S_{BCORR}), and a corrected green signal (such as corrected green signal S_{GCORR}).

It should be understood that method 400 should be interpreted as merely representative. In some embodiments, process blocks of method 400 may be performed simultaneously, sequentially, in a different order, or even omitted, without departing from the scope of this disclosure.

What is claimed is:

1. An image sensor, comprising:
a pixel array, comprising:
a plurality of filter-less pixels, wherein each pixel of the plurality of filter-less pixels comprises:
a blue light region;
a green light region; and
a red light region, wherein incoming light successively passes through the blue, green and red light regions, and
a readout circuitry, configured to:
receive color signal outputs comprising:
blue region signals from the blue light region,
green region signals from the green light region,
red region signals the red light region, and
correct color signal outputs with a correction algorithm, the correction algorithm comprising:
a blue light correction algorithm configured to correct the blue region signals by a first amount of green light and a second amount of red light absorbed within the blue light region,
a red light correction algorithm configured to correct the red region signals by a third amount of blue light and a fourth amount of green light absorbed within the red light region, and
a green light correction algorithm configured to correct the green region signals by a fifth amount of blue light and a sixth amount of red light absorbed within the green light region; and
output corrected color signals provided by the correction algorithm.

2. The image sensor of claim 1, wherein the blue region signals are defined as S_{B}=σ_{B}I_{0B}e^{-αbX2}(e^{αbX2-αbX1}−1)+δ_{GR}, wherein the green region signals are defined as S_{G}=σ_{G}I_{0G}e^{-αgX4}(e^{αgX4-αgX3}−1)+δ_{RB}, and wherein the red region signals are defined as S_{R}=σ_{R}I_{0R}e^{-αrX6}(e^{αrX6-αrX5}−1)+δ_{BG},
where:
S_{B}, S_{G}, and S_{R} are raw outputs from the blue region, the green region, and the red region, respectively,
X1 to X2 define boundaries of the blue region,
X3 to X4 define boundaries of the green region,
X5 to X6 define boundaries of the red region,
δ_{GR}, δ_{RB}, and δ_{BG} are additions to the raw outputs induced by cross talk due to green-red, red-blue, and blue-green light, respectively.
I₀ₙ (n=b,g,r) is light intensity of a selected wavelength,
σₙ(n=b,g,r) is an absorbed light to signal conversion parameter at a given wavelength, and
αb, αg, and αr are wavelength-specific absorption coefficients for b, g, and r, respectively.

3. The image sensor of claim 2, wherein σ_{B}I_{0B}=S_{B}e^{αbX2}/(e^{αbX2-αbX1}−1).

4. The image sensor of claim 2, wherein σ_{G}I_{0G}=S_{G}e^{αgX4}/(e^{αgX4-αgX3}−1).

5. The image sensor of claim 2, wherein σ_{R}I_{0R}=S_{R}e^{αrX6}/(e^{αrX6-αrX5}−1).

6. The image sensor of claim 2, wherein the correction algorithm is configured to ignore δ_{BG}, δ_{RB}, δ_{GR}, or a combination thereof when δ_{BG}, δ_{RB}, and δ_{GR}, or a combination thereof are less than a predetermined threshold.

7. The image sensor of claim 2, wherein the blue light correction algorithm is defined as S_{B}−[σ_{G}I_{0G}e^{-αgX2}(e^{αgX2-αgX1}−1)+σ_{R}I_{0R}e^{-αrX2}(e^{αrX2-αrX1}−1)].

8. The image sensor of claim 2, wherein the green light correction algorithm is defined as S_{G}−[S_{B}e^{αbX2}e^{-αbX4}(e^{αbX4-αbX3}−1)/(e^{αbX2-αbX1}−1)+S_{R}e^{αrX6}e^{-αrX4}(e^{αrX4-αrX3}−1)/(e^{αrX6-αrX5}−1)].

9. The image sensor of claim 2, wherein the red light correction algorithm is defined as S_{R}−[S_{B}e^{αbX2}e^{-αbX6}(e^{αbX6-αbX5}−1)/(e^{αbX2-αbX1}−1)+S_{G}e^{αgX4}e^{-αgX6}(e^{αgX6-αgX5}−1)/(e^{αgX4-αrX3}−1)].

10. The image sensor of claim 2, wherein the correction algorithm is a matrix correction algorithm, such that:
$$\{ \begin{matrix}{S}_{{B}_{CORR}} \\ {S}_{{G}_{CORR}} \\ {S}_{{R}_{CORR}}\end{matrix} \} = \{ \begin{matrix}1 & - \frac{{e}^{ag X 4} {e}^{- ag X 2} ( {e}^{ag X 2 - ag X 1} - 1 )}{{e}^{ag X 4 - agX 3} - 1} & - {e}^{arX 6} {e}^{- arX 2} ( {e}^{arX 6 - ar X 5} - 1 ) ( {e}^{ar X 6 - ar X 5} - 1 ) \\ - \frac{{e}^{ab X 2} {e}^{- ab X 4} ( {e}^{abx 4 - ab X 3} - 1 )}{{e}^{ab X 2 - abX 1} - 1} & 1 & - {e}^{ar X 6} {e}^{- ar X 4} ( {e}^{ar X 4 - ar X 3} - 1 ) ( {e}^{ar X 6 - ar X 5} - 1 ) \\ - \frac{{e}^{ab X 2} {e}^{- ab X 4} ( {e}^{abx 4 - ab X 3} - 1 )}{{e}^{ab X 2 - abX 1} - 1} & - \frac{{e}^{ag X 4} {E}^{- ag X 6} ( {e}^{ag X 6 - ag X 5} - 1 )}{{e}^{ag X 4 - arX 3} - 1} & 1\end{matrix} \} \{ \begin{matrix}{S}_{B} \\ {S}_{G} \\ {S}_{R}\end{matrix} \} .$$

11. A method of color-correcting the image sensor of claim 1, comprising:
receiving the color signal outputs comprising the blue region signals from the blue light region, the green region signals from the green light region, and the red region signals the red light region;
correcting the color signal outputs with the correction algorithm, comprising:
correcting the blue region signals with the blue light correction algorithm by the first amount of green light and the second amount of red light absorbed within the blue light region,
correcting the red region signals with the red light correction algorithm by the third amount of blue light and the fourth amount of green light absorbed within the red light region, and
correcting the green region signals with the green light correction algorithm by the fifth amount of blue light and the sixth amount of red light absorbed within the green light region; and
outputting the corrected color signals provided by the correction algorithm.

12. The method of claim 11, wherein the blue region signals are defined as S_{B}=σ_{B}I_{0B}e^{-αbX2}(e^{αbX2-αbX1}−1)+δ_{GR}, wherein the green region signals are defined as S_{G}=σ_{G}I_{0G}e^{-αgX4}(e^{αgX4-αgX3}−1)+δ_{RB}, and wherein the red region signals are defined as S_{R}=σ_{R}I_{0R}e^{-αrX6}(e^{αrX6-αrX5}−1)+δ_{BG},
where:
S_{B}, S_{G}, and S_{R} are raw outputs from the blue region, the green region, and the red region, respectively,
X1 to X2 define boundaries of the blue region,
X3 to X4 define boundaries of the green region,
X5 to X6 define boundaries of the red region,
δ_{GR}, δ_{RB}, and δ_{BG} are additions to the raw outputs induced by cross talk due to green-red, red-blue, and blue-green light, respectively.
I₀ₙ (n=b,g,r) is light intensity of a selected wavelength,
σₙ(n=b,g,r) is an absorbed light to signal conversion parameter at a given wavelength, and
αb, αg, and αr are wavelength-specific absorption coefficients for b, g, and r, respectively.

13. The method of claim 12, wherein σ_{B}I_{0B}=S_{B}e^{αbX2}/(e^{αbX2-αbX1}−1).

14. The method of claim 12, wherein σ_{G}I_{0G}=S_{G}e^{αgX4}/(e^{αgX4-αgX3}−1).

15. The method of claim 12, wherein σ_{R}I_{0R}=S_{R}e^{αrX6}/(e^{αrX6-αrX5}−1).

16. The method of claim 12, wherein correcting the color signal outputs further comprises ignoring δ_{BG}, δ_{RB}, δ_{GR}, or a combination thereof when δ_{BG}, δ_{RB}, δ_{GR}, or a combination thereof are less than a predetermined threshold.

17. The method of claim 12, wherein the blue light correction algorithm is defined as S_{B}−[σ_{G}I_{0G}e^{-αgX2}(e^{αgX2-αgX1}−1)+σ_{R}I_{0R}e^{-αrX2}(e^{αrX2-αrX1}−1)].

18. The method of claim 12, wherein the green light correction algorithm is defined as S_{G}−[S_{B}e^{αbX2}e^{-αbX4}(e^{αbX4-αbX3}−1)/(e^{αbX2-αbX1}−1)+S_{R}e^{αrX6}e^{-αrX4}(e^{αrX4-αrX3}−1)/(e^{αrX6-αrX5}−1)].

19. The method of claim 12, wherein the red light correction algorithm is defined as S_{Rcorr}=S_{R}−[S_{B}e^{αbX2}e^{-αbX6}(e^{αbX6-αbX5}−1)/(e^{αbX2-αbX1}−1)+S_{G}e^{αgX4}e^{-αgX6}(e^{αgX6-αgX5}−1)/(e^{αgX4-αrX3}−1)].

20. The method of claim 12, wherein the method further comprises correcting the color signal outputs with a correction matrix, such that:
$$\{ \begin{matrix}{S}_{{B}_{CORR}} \\ {S}_{{G}_{CORR}} \\ {S}_{{R}_{CORR}}\end{matrix} \} = \{ \begin{matrix}1 & - \frac{{e}^{ag X 4} {e}^{- ag X 2} ( {e}^{ag X 2 - ag X 1} - 1 )}{{e}^{ag X 4 - agX 3} - 1} & - {e}^{arX 6} {e}^{- arX 2} ( {e}^{arX 6 - ar X 5} - 1 ) ( {e}^{ar X 6 - ar X 5} - 1 ) \\ - \frac{{e}^{ab X 2} {e}^{- ab X 4} ( {e}^{abx 4 - ab X 3} - 1 )}{{e}^{ab X 2 - abX 1} - 1} & 1 & - {e}^{ar X 6} {e}^{- ar X 4} ( {e}^{ar X 4 - ar X 3} - 1 ) ( {e}^{ar X 6 - ar X 5} - 1 ) \\ - \frac{{e}^{ab X 2} {e}^{- ab X 4} ( {e}^{abx 4 - ab X 3} - 1 )}{{e}^{ab X 2 - abX 1} - 1} & - \frac{{e}^{ag X 4} {E}^{- ag X 6} ( {e}^{ag X 6 - ag X 5} - 1 )}{{e}^{ag X 4 - arX 3} - 1} & 1\end{matrix} \} \{ \begin{matrix}{S}_{B} \\ {S}_{G} \\ {S}_{R}\end{matrix} \} .$$
